(19) United States
(12) Patent Application Publication
(10) Pub. No.: US 2007/0053045 A1
(43) Pub. Date: Mar. 8, 2007

(54) Two sided torsional hinged mirror and method of manufacturing

(75) Inventors: Arthur Monroe Turner, Allen, TX (US); John W. Orcutt, Richardson, TX (US); Andrew Steven Dewa, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/367,256

(22) Filed: Mar. 3, 2006

Related U.S. Application Data
(60) Provisional application No. 60/676,662, filed on Apr. 28, 2005.

(51) Int. Cl. G02B 26/08

(52) U.S. Cl. 359/224

(57) ABSTRACT

A torsional hinged mirror structure having back-to-back reflective surfaces and suitable for use in a laser printer imaging system is disclosed. There is also disclosed an optical layer and a support structure that does not interfere with either of the two incident light beams as the two reflected beam sweeps.

This application claims the benefit of U.S. Provisional Application No. 60/676,662, filed on Apr. 28, 2005, entitled Simultaneous Front And Backside Reflective MEMS Mirrors For Use In Laser Scanning Imagers, which application is hereby incorporated herein by reference.

### TECHNICAL FIELD

The present invention relates to a torsional hinged mirror having back-to-back reflective surfaces and a method of manufacturing. The two sided mirror is particularly suitable for use in a Laser Scanning Imager of a Laser Printer.

### BACKGROUND

Pivoting or oscillating torsional hinged mirrors provide very effective, yet relatively inexpensive replacements for spinning polygon shaped mirrors previously used in black and white laser printers and some displays. Unfortunately, color laser printers with torsional hinged drive engines have not been as successful in replacing color inkjet printers.

The primary reason for this is because of the larger volume and desktop footprint laser printers require when compared to color ink jet printers. To really compete in the personal computer and the desktop printer market, a color printer system that can fit easily on a desktop and occupy as little volume as possible is required. Since color ink jet printers have small footprints and low price points, they represent the vast share of the market for desktop color printers.

Some laser printer manufacturers try to compete with ink jet printers by using the well known spinning polygon mirror. According to these systems, two laser light beams are directed toward the spinning polygon mirror from opposite sides. The two light paths are then folded and aligned to form an image and to reduce the overall required volume and footprint. These systems use only one polygon and are lower cost than the older multi-polygon systems. Unfortunately, all of the problems associated with spinning polygon mirror are still present.

Therefore, it would be advantageous to provide a torsional hinged drive engine having a smaller footprint and requiring less overall volume that is suitable for use with a color printer.

### SUMMARY OF THE INVENTION

These and other problems are generally solved or circumvented, and technical advantages are generally achieved, by embodiments of the present invention, which provides a torsional hinged mirror structure having back-to-back reflective surfaces and a method of manufacturing such a two sided mirror.

More specifically, the torsional hinged mirror structure of this invention comprises a center hinge plate having a pair of torsional hinges that extend away from a center section or member along a pivot axis. The hinge plate is preferably a MEMS device formed from a silicon layer or substrate. Each hinge of said pair of hinges includes a first end supported by a support structure. To facilitate mounting the torsional hinges, embodiments of the invention further include a support frame or first and second anchors attached to the first end of each of the torsional hinges. The second end of each of the torsional hinges is attached to and integrated with the central section or member of the hinge plate. The center section or member also includes first and second sides such that it is free to oscillate on the torsional hinges about the pivoting axis. The back surface of first and second mirror layers each having a back surface and a reflecting surface is bonded one each to said first and second sides of the center members of the hinge plate such that the reflecting surfaces face in opposite directions, and are substantially parallel to each other.

To use the torsional hinged mirror as a drive engine for a laser printer, there is also included a drive source that oscillates the torsional hinge mirror around its pivot axis at a selected frequency. The selected frequency is preferably the resonant frequency of the mirror. A first modulated beam of light is directed toward and reflected from one of the reflective surfaces, and in a similar manner, a second modulated beam of light is directed toward and reflected from the other reflective surface that is opposite the first reflective surface. Therefore, it will be understood that the two reflective surfaces and the two modulated light beams generate two modulated light beams that sweep through a selected angle for each oscillation of the mirror.

As will be appreciated by those skilled in the art, the drive source that maintains oscillations of the mirror device at its resonant frequency and with the desired amplitude cannot obscure or interfere with either of the incident light beams or the reflected sweeping light beams. Consequently, an inertia drive source such as provided by four piezoelectric elements coupled two each to each of the torsional hinges, or a permanent magnet attached on or proximate to one or both of the torsional hinges and that cooperates with a drive coil have been found to be especially suitable.

It will also be appreciated that the torsional hinged mirror must also be mounted or supported so that both reflective surfaces can receive and reflect a light beam. To this end, a slotted structure for supporting the torsional hinges mirror so that there is no interference with either of the two light beams has also been found to be particularly effective.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1A is a perspective view of a torsional hinged mirror having two reflective surfaces according to the teachings of the invention;

FIG. 1B is an exploded view of the mirror structure of FIG. 1A;

FIG. 2 is an optical layout of a torsional hinges mirror with two reflective surfaces, two laser beam sources and the resulting beam sweeps of the reflected laser beams;

FIG. 3A is a perspective view of two torsional hinges mirrors of the invention with an inertia drive source and a slotted support structure;

FIG. 3B is an enlarged view of the mirror and inertia drive structure, the two beams of light from the laser sources and the two reflected beam sweeps;

FIG. 3C is a further enlarged view of the mirror and inertia drive structure;

FIG. 4A is a perspective view of the torsional hinged mirror of the invention with the two laser sources and a permanent magnet and coil drive source mounted on a slotted support structure;

FIG. 4B is an enlarged view of the mirror and magnet drive structure;

FIGS. 5A and 5B show alternate permanent magnet and coil drive source structures suitable for use with the present invention; and

FIG. 6 illustrates a simple version of the torsional hinged mirror of this invention made or formed from a single layer of silicon.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

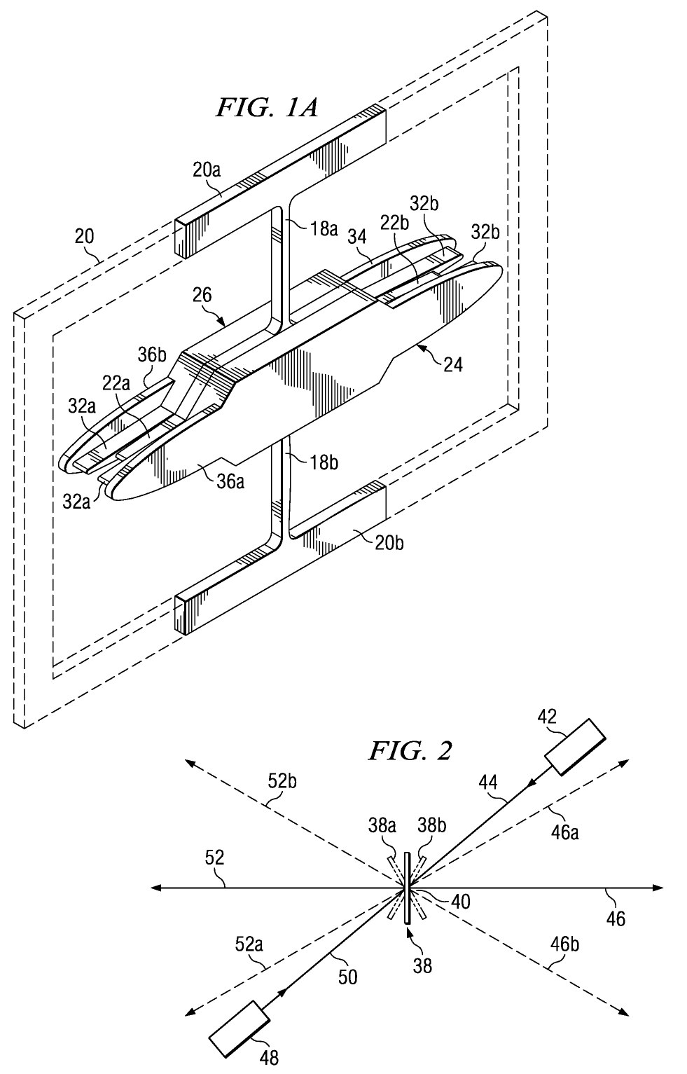

Referring now to FIGS. 1A and 1B, there is shown a simplified perspective view and a simplified exploded perspective view respectively of a torsional hinged mirror structure incorporating the teachings of the present invention. As shown, there is a hinge plate structure 10 comprising a center section 12 having a first side 14 and a second side 16, a pair of torsional hinges 18a and 18b, and a pair of anchor members 20a and 20b. Anchor members 20a and 20b may be replaced by a support frame 20, as indicated by the dashed lines in FIG. 1A. Preferably, the hinge plate 10 is etched, laser milled, or otherwise formed from a silicon substrate to include a pair of support spines 22a and 22b.

A first two level mirror plate or structure 24 and a second mirror plate or structure 26 are bonded one each to the first and second sides 14 and 16 of hinge plate 10. According to the illustrated embodiment and as can better be seen in the exploded view of FIG. 1B, each of the mirror plates 24 and 26 have two levels that include a first truss level 30 having spines 32a and 32b and a mirror level 34 that is integral with the truss level 30. Each of the mirror plates includes a reflective or mirror surface as indicated by reference number 36a and 36b. The two mirror plates are also preferably etched or laser milled from a silicon substrate.

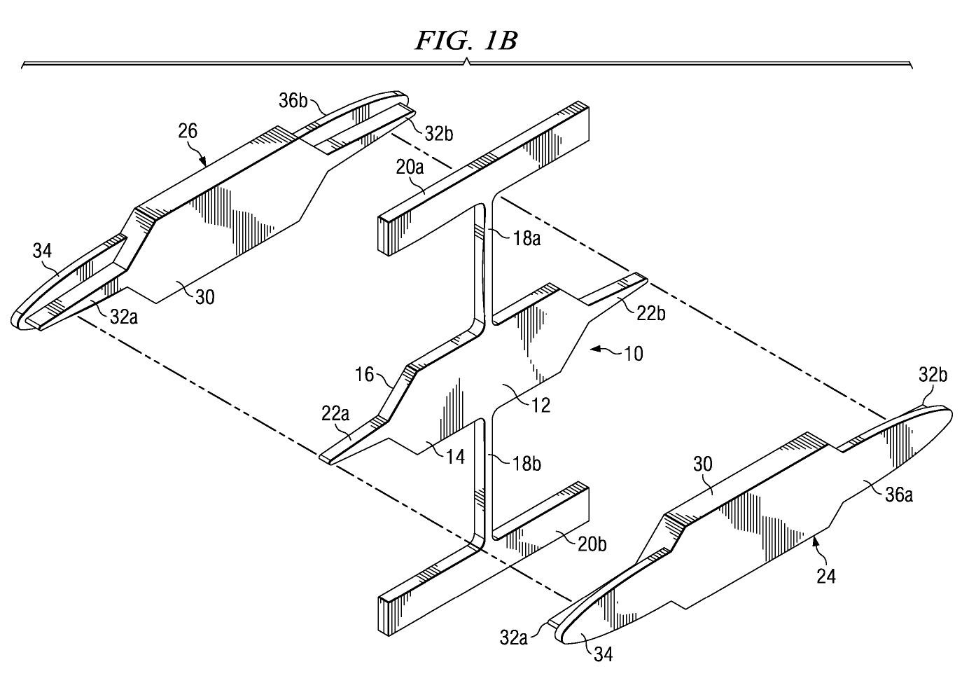

Referring to FIG. 2, there is illustrated a simplified optical layout for the two reflecting surfaces of the torsional hinged mirror structure of the present invention. As shown, a double sided oscillating mirror 38 is at rest in a neutral position, and pivots about an axis 40 between a first extreme position 38a and a second extreme position 38b. A first light source 42 directs an incident beam 44 such as a modulated laser beam onto a first reflective surface (the right hand surface in the figure) of the oscillating mirror 38 that reflects incident beam 44 in a different direction. As the mirror structure 38 oscillates between the two extreme positions 38a and 38b, the reflected beam 46 sweeps through a deflection angle that extends between the first outside limit 46a and a second outside limit 46b. In a similar manner, a second light source 48 directs an incident modulated light beam 50 at the second reflective surface (the left hand surface in the figure). The reflected light beam 52 also sweeps between a first outside limit 52a and a second outside limit 52b as the mirror oscillates between the first extreme position 38a and the second extreme position 38b. Thus, it can be seen that the torsional hinged mirror can generate a light beam sweep from each of the reflective surfaces at the same time. Although not shown, it will be appreciated by those skilled in the art that the reflected light beams can then be folded and aligned with each other on a photosensitive medium to produce a single image. It will also be appreciated that the two sources 42 and 48 of the light beams 44 and 50 must be positioned such that the structure supporting the mirror or the drive source that creates the oscillations does not interfere with either the incident light beams 44 and 50 or the reflected sweeping light beams 46 and 52.

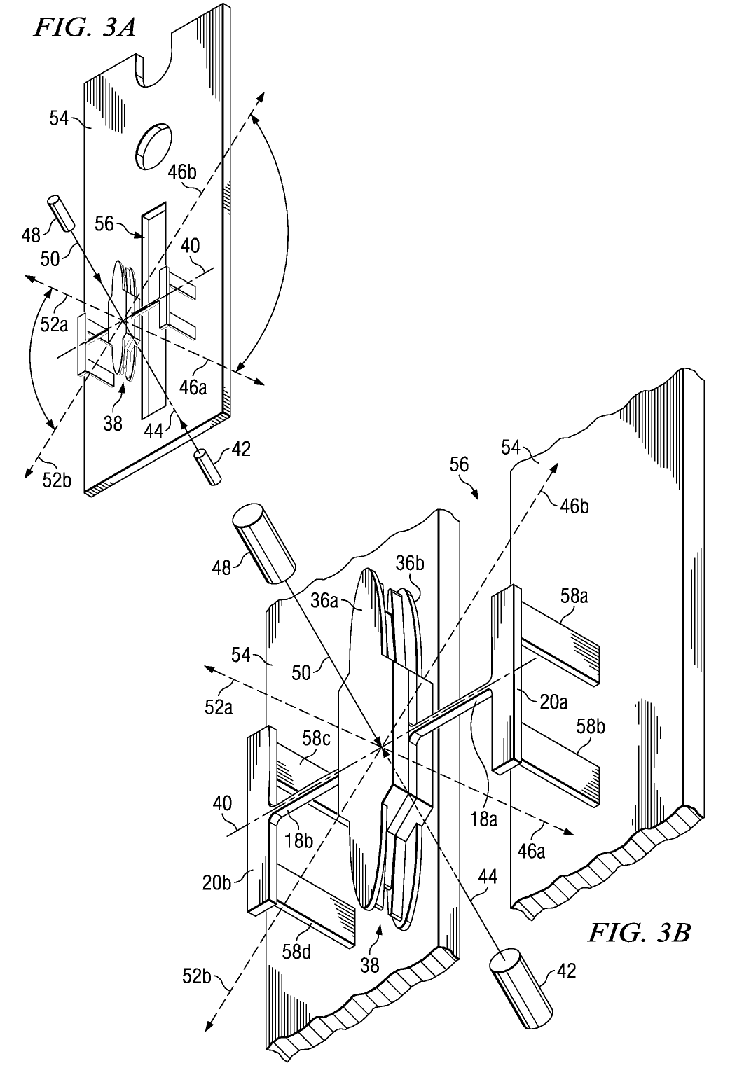

FIGS. 3A and 3B illustrate an inertia drive mechanism and a slotted support structure that does not interfere with the light beams and is suitable for use with the torsional hinged mirror structure having two reflective surfaces of this invention. FIG. 3C is an enlarged view of the mirror structure and the piezoelectric drive source of FIGS. 3A and 3B. Elements similar to the elements discussed above with respect to FIGS. 1A, 1B, and 2 carry the same reference numbers.

Therefore, referring now to FIGS. 3A and 3B, there is illustrated the two laser sources 42 and 48 directing laser beams 44 and 50 respectively to the two reflecting surface 36a an 36b of torsional hinged mirror 38 as it pivots on torsional hinges 18a and 18b about axis 40. Also, as shown, there is a support structure 54 defining a slot 56. The mirror structure 38 is supported on four piezoelectric elements 58a, 58b, 58c, and 58d that are driven at a selected frequency that preferably is substantially equal to the resonant frequency of the torsional hinged mirror 38, so as to cause the mirror 38 to oscillate at the resonant frequency. As shown in the figures and more specifically in FIG. 3C, torsional hinges 18a and 18b are connected to anchor members 20a and 20b. A first pair of piezoelectric elements 58a and 58b attached anchor member 20a on each side of the torsional hinge 18a to the support structure 54 (not shown in FIG. 3C). Similarly, a second pair of piezoelectric elements 58c and 58d is attached to anchor member 20b on each side of the torsional hinge 18b. The arrows 59a, 59b, 59c, and 59d illustrate the movement of the piezoelectric elements that creates the oscillating motion. Importantly, it is seen that with the slotted structure 54 and the position of the laser sources, there is no interference with the incident beams 44 and 50 or either of the two full beam sweeps by the support structure 54 or laser sources 42 and 48.

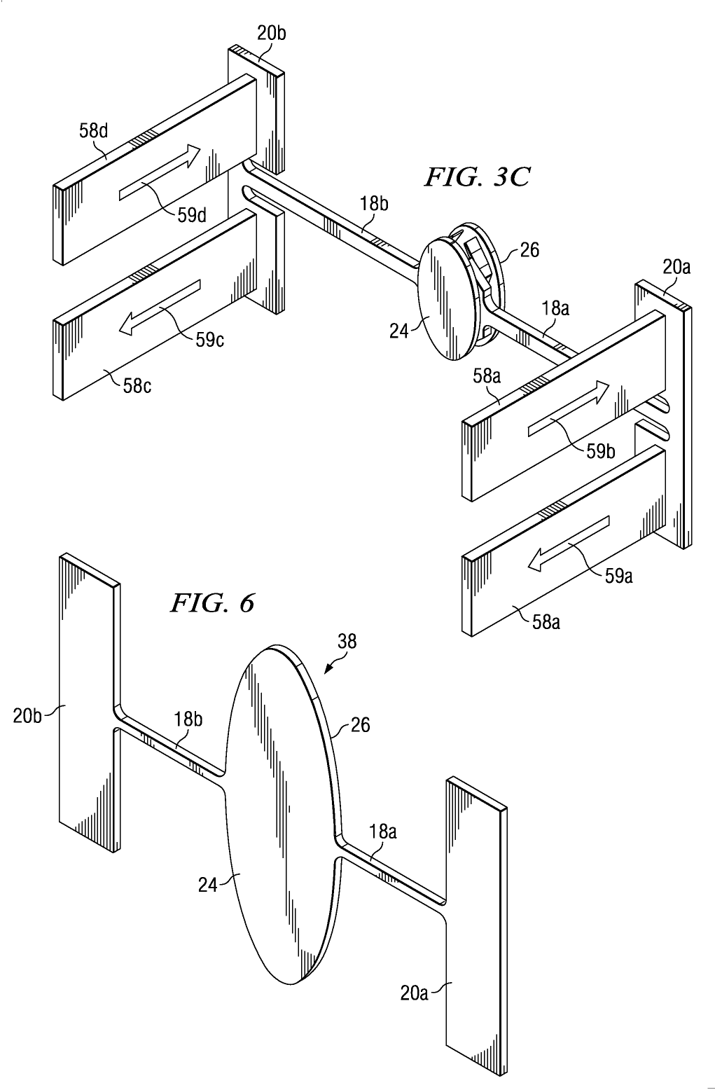

In addition to the inertia system discussed with respect to FIGS. 3A, 3B, and 3C, a permanent magnet and coil arrangement may also be used to cause oscillation of the torsional hinged mirror. The structure support 54 and laser sources 42 and 48shown in FIGS. 4A and 4B is similar to that of FIGS. 3A, 3B, and 3C, except that the locations of the laser sources 42 and 48 have been moved to illustrate that various arrangements are possible. The drive system of the embodiment of FIGS. 4A and 4B illustrate a similar mirror structure except magnet mounting areas 60a and 60b are included on the torsional hinge for supporting and mounting permanent magnets 62a and 62b. Also included are electrical coils 64a and 64b, which create a magnetic flux field that interacts with the permanent magnets to cause oscillation of the mirror structure.

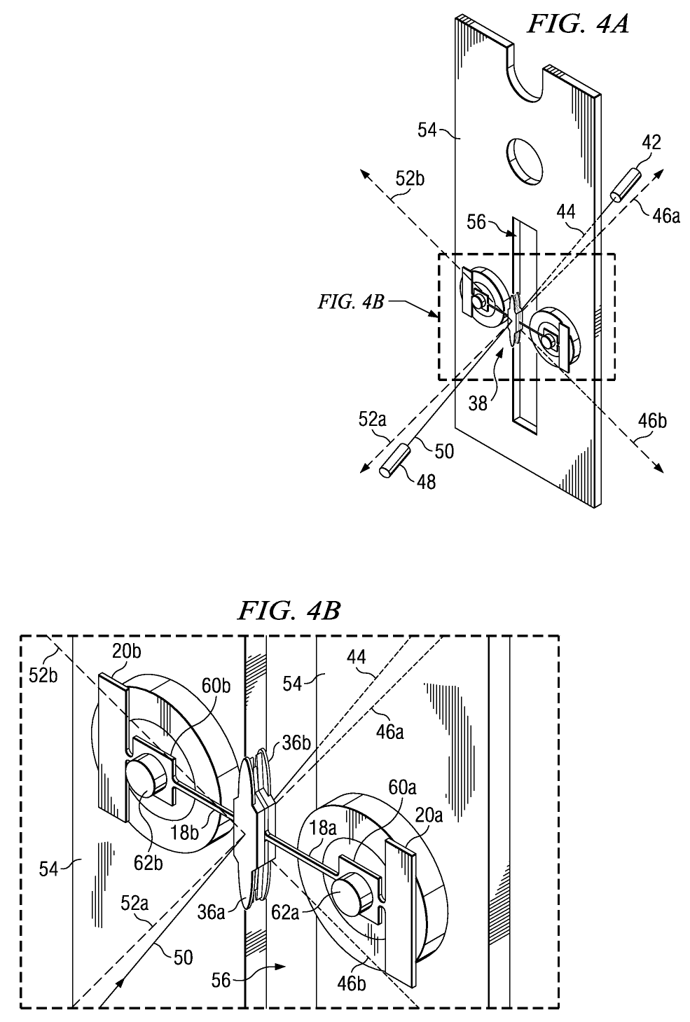

FIGS. 5A and 5B illustrate two additional torsional hinge structures that use permanent magnets and electrical coils as a drive source suitable for the two reflective surfaces of the torsional hinged structure of this invention.

The torsional hinged structures of FIGS. 5A and 5B are similar to the structure of FIG. 4B except that the magnet mounting areas 66a and 66b are not on the torsional hinges, but attached to the anchors 20a and 20b. The magnet mounting areas 66a and 66b are, however, in line with the torsional hinges and lie on the pivot axis. To help maintain the oscillations of the mirror at the resonant frequency and at the desired deflection amplitude with minimal power, the torsional hinges, according to the embodiments of FIGS. 5A and 5B, are attached to the anchors 20a and 20b with a reduced area of material. According to the embodiment of FIG. 5A, notches 68a and 68b separate the mounting areas 66a and 66b from the anchors 20a and 20b, except for the small areas at 70a and 70b. FIG. 5B operates in a somewhat similar manner except rather than cutting notches in the anchor, the areas 72a, 72b, 72c, and 72d that attach the torsional hinges 18a and 18b to the anchors 20a and 20b are thinned or reduced in thickness.

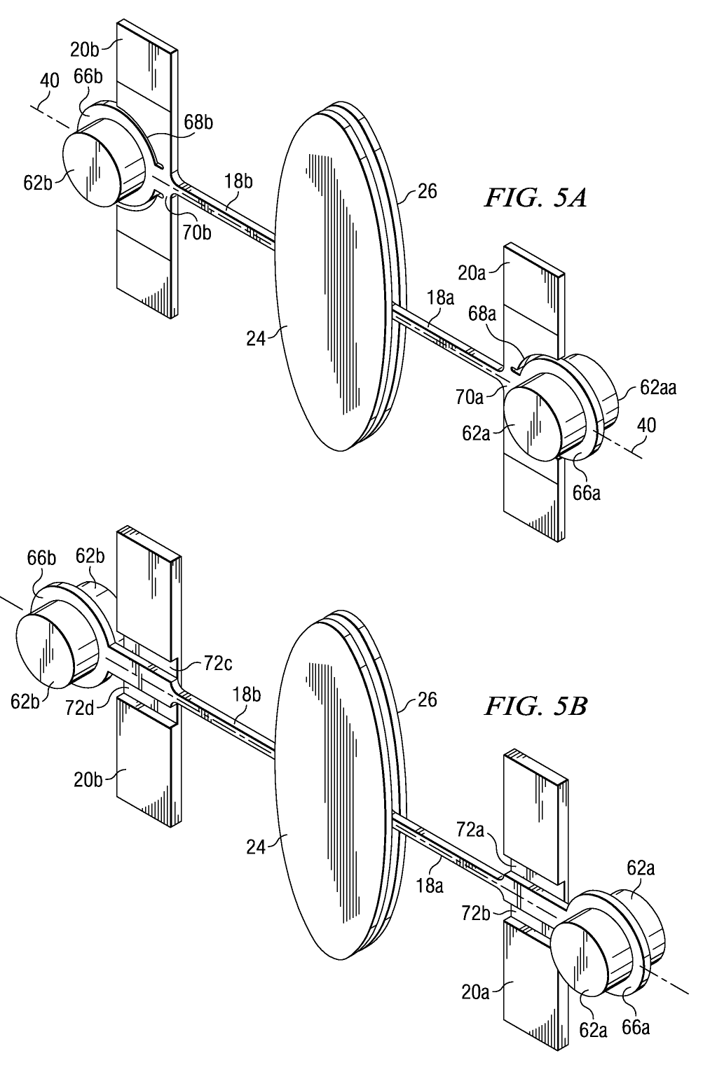

Referring now to FIG. 6, there is illustrated a very simple version of the present invention that can be etched or laser milled from a single silicon substrate or layer of material. As shown, the center portion or mirror, the torsional hinges 18a and 18b and the anchors 20a and 20b are all formed from the single layer of silicon. It will be appreciated that both sides of the silicon layer must be equally reflective if they are to act as reflective surfaces 24 and 26.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A torsional hinged mirror structure having two reflective surfaces comprising:
a pair of torsional hinges extending along a pivot axis, each hinge of said pair having a first end for mounting to a support structure and a second end;
a center portion located between and supported by said second end of each one of said pair of torsional hinges such that said center portion can oscillate freely about said pivot axis, said center member having a first side and a second side opposite said first side;
a first reflective surface on said first side of said center portion; and
a second reflective surface on said second side of said center portion.

2. The torsional hinged mirror structure of claim 1, wherein said first and second reflective surfaces are flat surfaces and are substantially parallel to each other.

3. The torsional hinged mirror structure of claim 1 wherein said pair of torsional hinges, said center portion and each of said first and second surfaces are formed from a single layer of silicon.

4. The torsional hinged mirror structure of claim 1 wherein said pair of torsional hinges and said center portion comprises a hinge plate and said first reflective surface comprises a first mirror layer bonded to said first side of said hinge plate and said second reflective surface comprises a second mirror layer bonded to said second side of said hinge plate.

5. The torsional hinged mirror structure of claim 1 wherein said pair of torsional hinges are made of silicon.

6. The torsional hinged mirror structure of claim 4 wherein said hinge plate is made of silicon.

7. The torsional hinged mirror of claim 6 wherein said first and second mirror layers are made of silicon.

8. The torsional hinged mirror structure of claim 1 wherein said first ends of each one of said pair of torsional hinges are mounted such that said torsional hinge structure is free to oscillate about said hinges, further comprising a drive source coupled to said torsional hinged mirror structure to oscillate said two reflective surfaces about said pivot axis through a selected deflection angle, a first beam of light directed toward and reflected from said first reflective surface and a second beam of light directed toward and reflected from said second reflective surface such that said reflected first and second beams of light sweep through said selected deflection angle.

9. The torsional hinged mirror of claim 8 further comprising a first and second anchor member connected to said first end of each one of said pair of torsional hinges.

10. The torsional hinged mirror of claim 9 wherein said drive sources is an inertia drive source.

11. The torsional hinged mirror structure of claim 10 wherein said inertia drive source comprises two pairs of piezoelectric actuators, one pair of said piezoelectric actuators mounted to one of said anchor members and the other pair of piezoelectric actuators mounted to said second anchor member.

12. The torsional hinged mirror structure of claim 9 wherein said drive source comprises a first permanent magnet mounted to a magnet support area defined on said first anchor along said pivot axis and further comprising a first drive coil mounted proximate said first permanent magnet to provide a magnetic drive flux that interacts with said first permanent magnet to cause said oscillations.

13. The torsional hinged mirror structure of claim 12 wherein said magnet area on said first anchor is defined by a slot separating said anchor member form said magnet support area except for a portion proximate said pivot axis.

14. The torsional hinged mirror structure of claim 12 further comprising a second permanent magnet mounted on a second magnet support area defined on said second anchor member along said pivot axis and further comprising a second drive coil mounted proximate said second permanent magnet.

15. The torsional hinged mirror structure of claim 8 wherein a magnet mounting area is defined on at least one of said torsional hinges and wherein said drive source comprises a first permanent magnet mounted on said magnet mounting area and a first drive coil mounted proximate said first permanent magnet.

16. The torsional hinged mirror structure of claim 15 wherein a magnet mounting area is defined on both of said torsional hinges and further comprising permanent magnets mounted on both of said magnet mounting areas and drive coils are mounted proximate both of said permanent magnets.

17. The torsional hinged mirror structure of claim 8 further comprising a slotted support structure and wherein said torsional hinged mirror is mounted so that said second beam of light is directed through said slot onto said second reflective surface and said reflected second beam of light sweeps back and forth through said slotted support structure.

18. The torsional hinged mirror of claim 8 wherein said torsional hinged mirror oscillates at its resonant frequency.

19. A method of fabricating a torsional hinged mirror system having two reflective structures for reflecting two separate beams of light as sweeping beams of light comprising the steps of:
providing a torsional hinged mirror having a center portion with two reflecting surfaces facing away form each other;
mounting said torsional hinged mirror on a support structure, said support structure defining a slot and said mirror mounted on said structure such that said mirror is supported above said slot with a first one of said reflecting surfaces facing said slot in said support structure and the other reflecting surface facing away from said support structure;
directing a first beam of light through said slot and onto said first reflecting surface facing said slot and such that said first beam of light is reflected;
directing a second beam of light onto said other reflecting surface that faces away from said support structure and such that said second beam of light is reflected; and
oscillating said torsional hinged mirror around said torsional hinges such that each of said first and second reflected beams of light sweep back and forth, said first reflected beam of light also passing through said slot defined in said support structure.

20. The method of claim 19 wherein said torsional hinged mirror is formed by bonding a first layer having a reflective surface to one side of a hinge plate and bonding a second layer having a reflective surface to another side of said hinge plate that is opposite said first side.

21. The method of claim 19 wherein said step of oscillating said torsional hinged mirror comprises the step of providing an inertial drive source to cause said mirror to oscillate.

22. The method of claim 19 wherein said step of oscillating said torsional hinged mirror comprises the step of providing a permanent magnet and electrical coil arrangement to cause said mirror to oscillate.

23. The method of claim 19 wherein said step of oscillating said torsional hinged mirror comprises oscillating said mirror at its resonant frequency.
